(19) United States
(12) Patent Application Publication
(10) Pub. No.: US 2006/0082531 A1
(43) Pub. Date: Apr. 20, 2006

(54) Liquid crystal display device and method for preventing flickering on liquid crystal display panel in liquid crystal display device

(75) Inventor: Jong-Seon Kim, Yongin-si (KR)

Correspondence Address: GREENBLUM & BERNSTEIN, P.L.C., 1950 ROLAND CLARKE PLACE, RESTON, VA, 20191, US

(73) Assignee: Hyundai Mobis Co., Ltd., Seoul (KR)

(21) Appl. No.: 11/045,276

(22) Filed: Jan. 31, 2005

(30) Foreign Application Priority Data
Oct. 15, 2004 (KR) 10-2004-0082685

(51) Int. Cl. G09G 3/36

(52) U.S. Cl. 345/87

(57) ABSTRACT

A liquid crystal display device includes an liquid crystal display panel and a panel driving unit that generates a driving signal to drive the liquid crystal display panel according to a video signal provided by a scaler. The liquid crystal display device further includes a user input unit that adjusts a brightness of a screen displayed on the liquid crystal display panel, and a microcomputer that controls the panel driving unit such that a voltage of the panel driving signal outputted from the panel driving unit can be maintained within a predetermined voltage range, such that a voltage of a panel driving signal inputted to a liquid crystal display panel is maintained at a constant level regardless of the adjustment of brightness, thereby enabling to preventing occurrence of flickering phenomenon.

### CROSS-REFERENCE TO RELATED APPLICATIONS

The present application is based on, and claims priority from, Korean Application Serial Number 10-2004-82685, filed on Oct. 15, 2004, the disclosure of which is hereby incorporated by reference herein in its entirety.

### FIELD OF THE INVENTION

The present invention relates to liquid crystal display (LCD) devices, and more particularly to an LCD device and a method for preventing a flickering on an LCD panel in an LCD device equipped with an LCD panel for displaying as an image a video signal input from the outside.

### BACKGROUND OF THE INVENTION

A recent trend for a vehicle is that an audio visual system as well as a car navigation system is provided where the audio visual system includes cassette tape players, compact disc players and radios, and the car navigation system receives an artificial satellite signal to display a current moving position on an electronic map and calculates an optimum route to a destination desired by a driver, and shows the optimum route to the driver.

An LCD device is largely used as an image display device of an audio visual system used in a vehicle.

However, there is a problem in an LCD panel of an LCD device thus described in that a voltage of a panel driving signal (VCOM) applied to the LCD panel from a panel driving unit also reaches a saturation state when a brightness is adjusted via a user input unit.

In other words, there is a problem in that when a brightness is adjusted to a lower level by the user input unit, a voltage of the panel driving signal (VCOM) goes higher, and alternatively when the brightness is adjusted to a higher level, the voltage of the panel driving signal (VCOM) goes lower, whereby, as a result, a flickering phenomenon of a screen of the LCD panel occurs when the brightness is the lowest level and the highest level as well.

### SUMMARY OF THE INVENTION

The present invention provides an LCD device and a method for preventing a flickering of an LCD panel adapted to maintain constant a voltage of a panel driving signal input to the LCD panel regardless of brightness adjustment of the LCD panel, thereby preventing the flickering phenomenon.

In accordance with a preferred embodiment of the present invention, an LCD device comprises an LCD panel and a panel driving unit for generating a driving signal for driving the LCD panel according to a video signal provided by a scaler. The LCD device further comprises a user input unit for adjusting a brightness of a screen displayed on the LCD panel. A microcomputer controls the panel driving unit such that a voltage of the panel driving signal outputted from the panel driving unit can be maintained within a predetermined voltage range when the brightness adjustment is detected from the user input unit.

In accordance with another preferred embodiment of the present invention, a method for preventing a flickering on an LCD panel in an LCD device, which comprises an LCD panel, a panel driving unit for generating a driving signal for driving the LCD panel according to a video signal provided by a scaler, and a user input unit for adjusting a brightness of a screen displayed on the LCD panel, comprises the processes of: detecting a voltage magnitude of a panel driving signal outputted from the panel driving unit when a brightness adjustment of a screen displayed on the LCD panel is detected; discriminating whether the voltage of the detected panel driving signal has escaped a predetermined voltage range; and controlling the panel driving unit to maintain the voltage of the panel driving signal within a predetermined voltage range when the voltage of the detected panel driving signal has escaped the predetermined voltage range.

### BRIEF DESCRIPTION OF THE DRAWINGS

For a better understanding of the nature and objects of the present invention, reference should be made to the following detailed description with the accompanying drawings, in which:

FIG. 1 is a schematic block diagram for illustrating an LCD device according to an embodiment of the present invention; and

FIG. 2 is a flow chart for illustrating a method for preventing a flickering on an LCD panel in an LCD device according to the present invention.

### DETAILED DESCRIPTION OF THE PREFERRED EMBODIMENT

The preferred embodiment of the present invention will now be described in detail with reference to the annexed drawings, where the present embodiment is not limiting the scope of the present invention but is given only as an illustrative purpose.

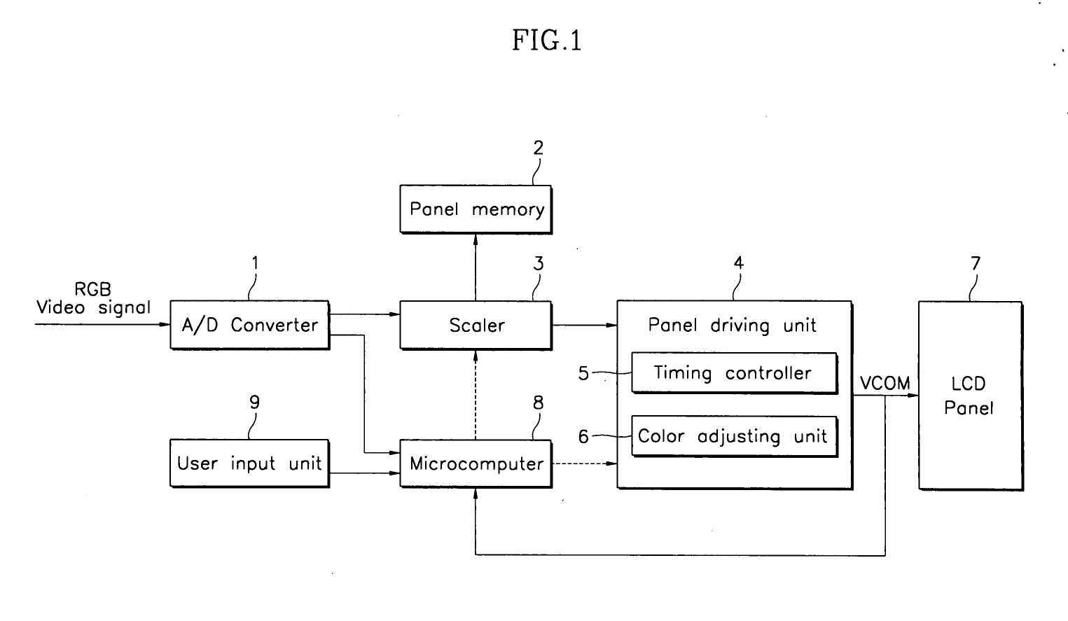

Referring to FIG. 1, an LCD device according to an embodiment of the present invention includes an analog to digital (A/D) converter 1 for converting an inputted RGB (Red-Green-Blue) analog video signal to an RGB digital video signal, a scaler 3 for adjusting the size of the digital video signal converted by the A/D converter 1 to fit to a screen of a liquid crystal display panel 7, a memory panel 2 for temporarily storing the video signal adjusted by the scaler 3, a panel driving unit 4 for generating a signal for driving the liquid crystal display panel 7 according to the video signal outputted from the scaler 3, a microcomputer 8 for controlling the respective apparatuses, and a user input unit 9 for adjusting the brightness of the screen displayed on the liquid crystal display panel 7.

The panel driving unit 4 includes a timing controller 5 for controlling a panel driving timing, a color adjusting unit 6 for converting a scanning method from an interlace to a non-interlace and for adjusting the panel driving signal according to an input adjustment of brightness or tint from the user input unit 9.

The user input unit 9 is equipped with a plurality of screen adjusting buttons for adjusting brightness and tint of the screen displayed on the liquid crystal display panel 7.

The microcomputer 8 detects the voltage of the panel driving signal (VCOM) outputted from the color adjusting unit 6 to discriminate whether the detected panel driving signal (VCOM) has deviated a predetermined voltage range when an input of the brightness adjustment is received via the user input unit 9, and sends a control signal to the color adjusting unit 6 so that the panel driving signal (VCOM) can be maintained within the predetermined voltage range. As a result, the color adjusting unit 6 adjusts the voltage of the video signal and sends the voltage-adjusted signal to the liquid crystal display panel 7.

Conventionally, the color adjusting unit 6 is embodied by chroma Integrated Circuit (IC), and the microcomputer 8 changes a register value of the chroma IC to adjust the panel driving signal outputted from the chroma IC.

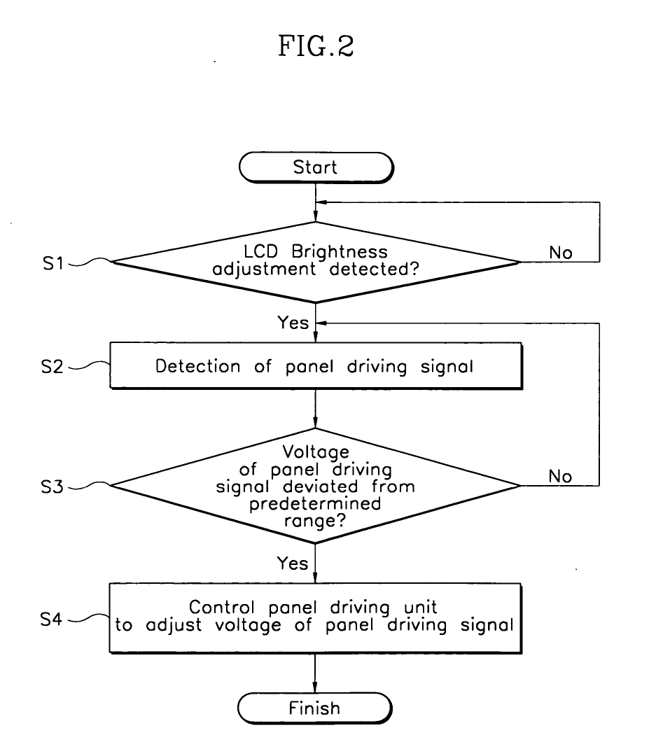

Now, referring to FIG. 2, the microcomputer 8 discriminates whether the brightness adjustment has been inputted from the user input unit 9 (Step S1). As a result of the discrimination at Step S1, if the brightness adjustment has been inputted to be detected, the microcomputer 8 detects a magnitude of the voltage of the panel driving signal (VCOM) outputted from the color adjusting unit 6 (Step S2). The microcomputer 8 at Step S3 discriminates whether the voltage of the panel driving signal (VCOM) has deviated from the predetermined voltage range. As a result of the discrimination at Step S3, if the panel driving signal (VCOM) has freed itself from the predetermined voltage range, the microcomputer 8 at Step S4 sends a control signal to the color adjusting unit 6 to maintain the voltage of the panel driving signal (VCOM) within the predetermined voltage range.

According to the construction thus described, the panel driving signal outputted from the color adjusting unit 6 of the panel driving unit is detected when the brightness of the screen displayed on the liquid crystal display panel is adjusted, and when the voltage of the panel driving signal thus detected is above the predetermined voltage, the color adjusting unit 6 is controlled to prompt a signal of less than a predetermined voltage to be outputted, thereby preventing the occurrence of the flickering phenomenon on the liquid crystal display panel.

The foregoing description of the preferred embodiment of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto, and their equivalents.

As apparent from the foregoing, there is an advantage in the LCD device and the method for preventing a flickering on an LCD panel in the LCD device thus described according to the embodiment of the present invention in that a voltage of a panel driving signal inputted to a liquid crystal display panel is maintained at a constant level regardless of the adjustment of brightness of a screen displayed on the liquid crystal display panel, thereby enabling to preventing occurrence of flickering phenomenon.

1. A liquid crystal display device equipped with an liquid crystal display panel and a panel driving unit that generates a driving signal to drive the liquid crystal display panel according to a video signal provided by a scaler, wherein the liquid crystal display device comprises:
a user input unit that adjusts a brightness of a screen displayed on the liquid crystal display panel; and
a microcomputer that controls the panel driving unit such that a voltage of the panel driving signal outputted from the panel driving unit can be maintained within a predetermined voltage range when the brightness adjustment is detected from the user input unit.

2. A method for preventing flickering on an liquid crystal display panel in an liquid crystal display device equipped with an liquid crystal display panel, a panel driving unit that generates a driving signal to drive the liquid crystal display panel according to a video signal provided by a scaler, and a user input unit that adjusts a brightness of a screen displayed on the liquid crystal display panel, wherein the method for preventing flickering on an liquid crystal display panel in an liquid crystal display device comprises:
detecting a voltage magnitude of a panel driving signal outputted from the panel driving unit when a brightness adjustment of a screen displayed on the liquid crystal display panel is detected;
determining whether the voltage of the detected panel driving signal has escaped a predetermined voltage range; and
controlling the panel driving unit to maintain the voltage of the panel driving signal within a predetermined voltage range when the voltage of the detected panel driving signal has escaped the predetermined voltage range.
